(19) United States
(12) Patent Application Publication
(10) Pub. No.: US 2004/0254298 A1
(43) Pub. Date: Dec. 16, 2004

(54) Golf ball incorporating styrenic block copolymer and urethane

(76) Inventors: Hyun Jin Kim, Carlsbad, CA (US); Hong Guk Jeon, Carlsbad, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/460,378

(22) Filed: Jun. 12, 2003

(51) Int. Cl. C08L 53/02

(52) U.S. Cl. 525/92 C

(57) ABSTRACT

Compositions, particularly preferred for use in golf ball cores, intermediate layers, and cover layers, incorporate a blend or copolymer of styrenic block copolymer and urethane. The compositions provide for superior mechanical performance and ease of processing.

### BACKGROUND OF THE INVENTION

1. Field of the Invention

The present invention relates to polymer compositions for use in golf ball cores, intermediate layers, and cover layers providing for superior performance. The present invention also relates to methods of manufacture of these compositions.

2. Description of Related Art

Golf balls often incorporate polymeric materials. These materials are chosen because they provide good properties with respect to cost, weight, and durability in a variety of uses. Golf balls generally include a core and at least one cover layer surrounding the core. Balls can be classified as two-piece, multi-layer, or wound balls. Two-piece balls include a spherical inner core and an outer cover layer. Multi-layer balls include a core, a cover layer and one or more intermediate (or mantle) layers. The intermediate layers themselves may include multiple layers. Wound balls include a core, a rubber thread wound under tension around the core to a desired diameter, and a cover layer, typically of balata material.

Material characteristics of the compositions used in sports equipment, including golf ball layers are important in determining the durability and performance of the equipment. For example, with respect to golf balls, the composition of a golf ball cover layer is important in determining the ball's durability, scuff resistance, speed, shear resistance, spin rate, feel, and “click” (the sound made when a golf club head strikes the ball). The composition of an intermediate layer is important in determining the ball's spin rate, speed, and durability. The composition and resulting mechanical properties of the core are important in determining the ball's coefficient of restitution (C.O.R.), i.e., the ratio of the ball's post-impact to pre-impact speed, which affects ball speed and distance when hit, as well as core compression, i.e., a measure of the deflection on the surface of the ball when a standard force is applied. In addition to the performance factors discussed above, processability also is considered when selecting a formulation for a golf ball composition. Good processability allows for ease of manufacture using a variety of methods known for making golf ball layers, while poor processability may lead to avoidance of use of particular materials, even when those materials provide for good mechanical properties.

Various materials having different physical properties are used to make cover layers to create a ball having the most desirable performance possible. For example, many modern cover layers are made using soft or hard ionomer resins, elastomeric resins or blends of these. Ionomeric resins used generally are copolymers of an olefin and the metal salt of an unsaturated carboxylic acid(s), or are ionomeric terpolymers having at least one additional monomer polymerized into its structure. These resins vary in resiliency, flexural modulus, and hardness. Examples of these resins include those marketed under the tradenames SURLYN (E.I. du Pont de Nemours & Company, Wilmington, Del.) and IOTEK (ExxonMobil Corporation, Irving, Tex.).

Various materials having different physical properties are used to make sports equipment having the most desirable performance possible. One material generally cannot optimize all of the important properties for a particular piece of equipment. For golf balls, properties such as feel, speed, spin rate, resilience and durability all are important, but improvement of one of these properties by use of a particular material often may lead to worsening of another. For example, ideally, a golf ball cover should have good feel and controllability, without sacrificing ball speed, distance, or durability. Despite the broad use of copolymeric ionomers in golf balls, their use alone in, for example, a ball cover may be unsatisfactory. A cover providing good durability, controllability, and feel would be difficult to make using only a copolymeric ionomer resin having a high flexural modulus, because the resulting cover, while having good distance and durability, also will have poor feel and low spin rate, leading to reduced controllability of the ball. Also, the use of particular elastomeric resins alone may lead to compositions having unsatisfactory properties, such as poor durability and low ball speed.

Therefore, to improve the properties of sports equipment produced from polymers, the polymer materials discussed above may be blended to produce improved equipment parts. For example, compositions for use in golf balls have involved blending high-modulus copolymeric ionomer with lower-modulus copolymeric ionomer, terpolymeric ionomer, or elastomer. As discussed above, ideally a golf ball cover should provide good feel and controllability, without sacrificing the ball's distance and durability. Therefore, a copolymeric ionomer having a high flexural modulus often is combined in a cover composition with a terpolymeric ionomer or an elastomer having a low flexural modulus. The resulting intermediate-modulus blend possesses a good combination of hardness, spin and durability.

One material used in golf balls is polyurethane. Polyurethane typically is formed as the reaction product of a diol or polyol, along with an isocyanate. The reaction also may incorporate a chain extender configured to harden the polyurethane formed by the reaction. Thermoplastic polyurethanes have generally linear molecular structures and incorporate physical cross-linking that may be reversibly broken at elevated temperatures. As a result, thermoplastic polyurethanes may be made to flow readily, as is required for injection molding processes. In contrast, thermoset polyurethanes have generally networked structure that incorporate irreversible chemical cross-linking. As a result, thermoset polyurethanes do not flow freely, even when heated.

Thermoplastic and thermoset polyurethanes both have been used in, for example, golf ball layers, and each provides for certain advantages. Because of their excellent flowability, thermoplastic polyurethanes may be positioned readily around a golf ball core using injection molding. Unfortunately, parts comprising thermoplastic polyurethane exhibit poor durability; for example, golf balls from thermoplastic polyurethane exhibit poor shear-cut resistance. Thus, while thermoplastic polyurethane parts are less expensive to make due to their superior processability, they are not favored due to the resulting inferior performance. In contrast, thermoset polyurethane exhibits high shear-cut resistance and is much more scuff- and cut-resistant than thermoplastic polyurethane. However, the irreversible cross-links in the thermoset polyurethane structure make it unsuitable for use in injection molding processes conventionally used for thermoplastic materials.

Examples of use of thermoplastic polyurethane in golf ball compositions are discussed in U.S. Pat. No. 5,759,676 to Wu, which discloses thermoplastic polyurethane utilized in blends for mantle and cover layers, and in U.S. Pat. No. 6,319,152 to Takesue, which teaches blending of a thermoplastic polyurethane with a styrene-based block copolymer to increase the scuff resistance of the resulting golf ball cover. The Takesue patent discloses that because thermoplastic polyurethanes are “inexpensive and easy to mold, these elastomers are regarded as an excellent cover stock substitute for balata material. However, the thermoplastic polyurethane elastomers are still insufficient in scuff resistance upon iron shots.” Thermoplastic polyurethanes also are used for making mantle layers to give the feel of a wound ball to non-wound constructions. Such a mantle is disclosed in U.S. Pat. No. 5,759,676 to Cavallaro et al.

Though they are more expensive to process than thermoplastic polyurethanes, thermoset polyurethanes also have been used in golf ball layers. For example, U.S. Pat. No. 6,132,324 to Hubert discloses a golf ball having a cover formed from thermoset polyurethane. The patent teaches a method for casting a thermoset polyurethane cover over an ionomer inner layer, including a step of measuring the viscosity “over time, so that the subsequent steps of filling each mold half, introducing the core into one half and closing the mold may be properly timed for accomplishing centering of the core cover halves fusion and overall uniformity.” The additional steps involved in casting a layer over those needed for injection molding the layer lead to added complexity and expense. Another patent discussing use of thermoset polyurethane is U.S. Pat. No. 6,435,987 to Dewanjee. This patent teaches thermosetting polyurethane comprising a toluene diisocyanate-based prepolymer, a second diisocyanate prepolymer, and a curing agent. Again, this method makes use of casting because the materials used would not be well suited to injection molding. One attempt to successfully use thermoplastic polyurethane in golf ball covers is disclosed in U.S. Pat. No. 6,123,628 to Ichikawa et al. This patent discloses golf ball covers incorporating the reaction product of a thermoplastic polyurethane with an isocyanate compound. In this patent, the cross-linking reaction is completed during extrusion. The completed golf ball covers are thermoplastic, and they provide for improved scuff resistance, though they do not exhibit improvements in other mechanical properties.

Despite the many polymer compositions used for making golf balls, none have been found to be completely satisfactory with respect to optimizing ball performance and ease of processing. In view of the above, it is apparent that improved golf balls are needed that provide optimal performance and durability properties, while demonstrating ease of manufacture. The present invention fulfills this need and provides further related advantages.

### SUMMARY OF THE INVENTION

The present invention resides in a composition comprising a styrenic block copolymer and a urethane. In a preferred embodiment, the styrenic block copolymer and urethane are combined to form a random copolymer, a graft copolymer, or a block copolymer. The composition can further incorporate a polyolefin. In preferred embodiments, the polyolefin is a functionalized olefin, preferably one in which 1% to 30%, more preferably 5% to 25%, and more preferably 9% to 16% or 16% to 25% by weight of monomer units in comprise a carboxylic acid functional group or an ester functional group.

In preferred embodiments, the functionalized polyolefin incorporate carboxylic acid functional groups, of which greater than 1%, more preferably greater than 10%, more preferably greater than 20%, more preferably greater than 40%, more preferably greater than 70%, more preferably greater than 99%. Preferred functionalized polyolefin incoroprate fatty acid salts, such as an ionomer. These compositions incorporating ionomer can further include urethane, rubber, or mixtures of these.

The present invention also is embodied in golf balls incorporating the above-described compositions. The golf ball can further include UV stabilizers, photo stabilizers, antioxidants, colorants, dispersants, mold releasing agents, processing aids, or fillers, such as a filler that increases or decreases the density of the golf ball. The golf ball can have a core, cover layer, or one or more intermediate layers incorporating the composition. The core of the golf ball can include an inner and one or more outer cores, or liquid. The golf ball can incorporate a layer of rubber thread situated between the core and the cover layer of the golf ball. In preferred embodiments, the core or cover layer incorporates greater than 5% by weight of the styrenic block copolymer and urethane, more preferably greater than 10%, more preferably greater than 20%, and most preferably greater than 40%.

The present invention also resides in a method for preparing a portion of a golf ball, comprising preparing a composition comprising styrenic block copolymer and urethane, and forming the composition into the portion. The step of preparing preferably incorporates copolymerizing at least a portion of the styrenic block copolymer with the urethane to form a random copolymer, graft copolymer, or block copolymer. The step of forming the composition into the portion can incorporate injection molding the composition to form the portion, and the step of preparing the composition can incorporate dry-blending the composition, or mixing the composition using a mill, internal mixer or extruder.

Other features and advantages of the present invention should become apparent from the following detailed description of the preferred embodiments.

### DETAILED DESCRIPTION OF THE PREFERRED EMBODIMENTS

The present invention is embodied in a polymer blend of styrenic block copolymer (SBC) and urethane as all or part of a polymer composition. These blends are particularly suited for use in golf balls. The polymer blend of SBC and urethane also may be compatibilized through functionalization of SBC or urethane, or through a separate compabilizer. Such compatibilization may lead to formation of a copolymer of SBC and urethane in the composition. The SBC and urethane also may be introduced into the composition as a random or block copolymer of SBC and urethane. An example of such a copolymer is Septon S5865, or the materials described in U.S. Pat. No. 5,436,295 to Nishikawa et al. and assigned to Kuraray Company of Kurashiki, Japan. The SBC/urethane blend or copolymer can be used as essentially the entire composition for a golf ball portion, or it can be used as part of a composition incorporating other polymers conventionally used in golf balls, such as ionomers, urethanes, rubbers, or blends of these. In particular, the SBC/urethane copolymer can be used as a compatibilizer in an otherwise conventional polymer blend. The SBC/urethane copolymer provides for improved mechanical golf ball properties, while providing ease of processability and compatibility with a variety of other polymer resins.

The styrenic block copolymer used in the SBC/urethane blend or copolymer described above is itself a copolymer of styrene with either butadiene, isoprene, or a mixture of the two. Additional unsaturated monomers may be added to the structure of the styrenic block copolymer as needed for property modification of the resulting SBC/urethane copolymer. The styrenic block copolymer can be a diblock or a triblock styrenic polymer. Examples of such styrenic block copolymers are described in, for example, U.S. Pat. No. 5,436,295 to Nishikawa et al. The styrenic block copolymer can have any known molecular weight for such polymers, and it can possess a linear, branched, star, dendrimeric or combination molecular structure. The styrenic block copolymer can be unmodified by functional groups, or it can be modified by hydroxyl group, carboxyl group, or other functional groups, either in its chain structure or at one or more terminus. The styrenic block copolymer can be obtained using any common process for manufacture of such polymers. The styrenic block copolymers also may be hydrogenated using well-known methods to obtain a partially or fully saturated diene monomer block.

The urethane used in the SBC/urethane blend or copolymer described above is the reaction product of a diol or polyol and an isocyanate, with or without a chain extender. Isocyanates used for making the urethanes of the present invention encompass diisocyanates and polyisocyanates. Examples of suitable isocyanates include the following: trimethylene diisocyanate, tetramethylene diisocyanate, pentamethylene diisocyanate, hexamethylene diisocyanate, ethylene diisocyanate, diethylidene diisocyanate, propylene diisocyanate, butylene diisocyanate, bitolylene diisocyanate, tolidine isocyanate, isophorone diisocyanate, dimeryl diisocyanate, dodecane-1,12-diisocyanate, 1,10-decamethylene diisocyanate, cyclohexylene-1,2-diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis (isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclohexyl isocyanate, 1-isocyanato-3,3,5-trimethyl-5-isocyanatomethylcyclohexane, cyclohexyl isocyanate, dicyclohexylmethane 4,4′-diisocyanate, 1,4-bis(isocyanatomethyl) cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, meta-xylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianisidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, triphenylmethane 4,4′,4″-triisocyanate, isocyanatoethyl methacrylate, 3-isopropenyl-α,α-dimethylbenzyl-isocyanate, dichlorohexamethylene diisocyanate, ω,ω′-diisocyanato-1,4-diethylbenzene, polymethylene polyphenylene polyisocyanate, polybutylene diisocyanate, isocyanurate modified compounds, and carbodiimide modified compounds, as well as biuret modified compounds of the above polyisocyanates. Each isocyanate may be used either alone or in combination with one or more other isocyanates. These isocyanate mixtures can include triisocyanates, such as biuret of hexamethylene diisocyanate and triphenylmethane triisocyanate, and polyisocyanates, such as polymeric diphenylmethane diisocyanate.

Polyols used for making the polyurethane in the copolymer include polyester polyols, polyether polyols, polycarbonate polyols and polybutadiene polyols. Polyester polyols are prepared by condensation or step-growth polymerization utilizing diacids. Primary diacids for polyester polyols are adipic acid and isomeric phthalic acids. Adipic acid is used for materials requiring added flexibility, whereas phthalic anhydride is used for those requiring rigidity. Some examples of polyester polyols include poly(ethylene adipate) (PEA), poly(diethylene adipate) (PDA), poly(propylene adipate) (PPA), poly(tetramethylene adipate) (PBA), poly(hexamethylene adipate) (PHA), poly(neopentylene adipate) (PNA), polyols composed of 3-methyl-1,5-pentanediol and adipic acid, random copolymer of PEA and PDA, random copolymer of PEA and PPA, random copolymer of PEA and PBA, random copolymer of PHA and PNA, caprolactone polyol obtained by the ring-opening polymerization of ε-caprolactone, and polyol obtained by opening the ring of β-methyl-ε-valerolactone with ethylene glycol can be used either alone or in a combination thereof. Additionally, polyester polyol may be composed of a copolymer of at least one of the following acids and at least one of the following glycols. The acids include terephthalic acid, isophthalic acid, phthalic anhydride, oxalic acid, malonic acid, succinic acid, pentanedioic acid, hexanedioic acid, octanedioic acid, nonanedioic acid, adipic acid, azelaic acid, sebacic acid, dodecanedioic acid, dimer acid (a mixture), ρ-hydroxybenzoate, trimellitic anhydride, ε-caprolactone, and β-methyl-δ-valerolactone. The glycols includes ethylene glycol, propylene glycol, butylene glycol, pentylene glycol, 1,4-butanediol, 1,5-pentanediol, 1,6-hexanediol, neopentylene glycol, polyethylene glycol, polytetramethylene glycol, 1,4-cyclohexane dimethanol, pentaerythritol, and 3-methyl-1,5-pentanediol.

Polyether polyols are prepared by the ring-opening addition polymerization of an alkylene oxide (e.g. ethylene oxide and propylene oxide) with an initiator of a polyhydric alcohol (e.g. diethylene glycol), which is an active hydride. Specifically, polypropylene glycol (PPG), polyethylene glycol (PEG) or propylene oxide-ethylene oxide copolymer can be obtained. Polytetramethylene ether glycol (PTMG) is prepared by the ring-opening polymerization of tetrahydrofuran, produced by dehydration of 1,4-butanediol or hydrogenation of furan. Tetrahydrofuran can form a copolymer with alkylene oxide. Specifically, tetrahydrofuran-propylene oxide copolymer or tetrahydrofuran-ethylene oxide copolymer can be formed. A polyether polyol may be used either alone or in a mixture.

Polycarbonate polyol is obtained by the condensation of a known polyol (polyhydric alcohol) with phosgene, chloroformic acid ester, dialkyl carbonate or diallyl carbonate. Particularly preferred polycarbonate polyol contains a polyol component using 1,6-hexanediol, 1,4-butanediol, 1,3-butanediol, neopentylglycol or 1,5-pentanediol. A polycarbonate polyol can be used either alone or in a mixture.

Polybutadiene polyol includes liquid diene polymer containing hydroxyl groups, and an average of at least 1.7 functional groups, and may be composed of diene polymer or diene copolymer having 4 to 12 carbon atoms, or a copolymer of such diene with addition to polymerizable α-olefin monomer having 2 to 2.2 carbon atoms. Specific examples include butadiene homopolymer, isoprene homopolymer, butadiene-styrene copolymer, butadiene-isoprene copolymer, butadiene-acrylonitrile copolymer, butadiene-2-ethyl hexyl acrylate copolymer, and butadiene-n-octadecyl acrylate copolymer. These liquid diene polymers can be obtained, for example, by heating a conjugated diene monomer in the presence of hydrogen peroxide in a liquid reactant. A polybutadiene polyol can be used either alone or in a mixture.

As stated above, urethane used within the scope of the present invention also may incorporate chain extenders. Non-limiting examples of these extenders include polyols, polyamine compounds, and mixtures of these. Polyol extenders may be primary, secondary, or tertiary polyols. Specific examples of monomers of these polyols include: trimethylolpropane (TMP), ethylene glycol, 1,3-propanediol, 1,4-butanediol, 1,5-pentanediol, 1,6-hexanediol, propylene glycol, dipropylene glycol, 1,2-butanediol, 1,3-butanediol, 2,3-butanediol, 1,2-pentanediol, 2,3-pentanediol, 2,5-hexanediol, 2,4-hexanediol, 2-ethyl-1,3-hexanediol, cyclohexanediol, and 2-ethyl-2-(hydroxymethyl)-1,3-propanediol.

Suitable polyamines that may be used as chain extenders include primary, secondary and tertiary amines; polyamines have two or more amines as functional groups. Examples of these include: aliphatic diamines, such as tetramethylenediamine, pentamethylenediamine, hexamethylenediamine; alicyclic diamines, such as 3,3′-dimethyl-4,4′-diamino-dicyclohexyl methane, or aromatic diamines, such as 4,4′-methylene bis-2-chloroaniline, 2,2′,3,3′-tetrachloro-4,4′-diaminophenyl methane, p,p′-methylenedianiline, p-phenylenediamine or 4,4′-diaminodiphenyl; and 2,4,6-tris(dimethylaminomethyl) phenol. Aromatic diamines have a tendency to provide a stiffer (i.e., having a higher Mooney viscosity) product than aliphatic or cycloaliphatic diamines. A chain extender may be used either alone or in a mixture.

When the styrenic block copolymer and urethane form an SBC/urethane copolymer, they may form a random, graft, or block copolymer. The block copolymer may have a diblock or triblock structure. An example of a block copolymer preparation is provided in U.S. Pat. No. 5,436,295 to Nishikawa et al.

As stated above, the SBC/urethane blend or copolymer may be used alone or as part of a polymer composition in the golf balls of the present invention. The SBC/urethane blend or copolymer may be blended with additional polymers including, but not limited to, the following: thermoplastic elastomer, thermoset elastomer, synthetic rubber, thermoplastic vulcanizate, copolymeric ionomer, terpolymeric ionomer, polycarbonate, polyolefin, polyamide, copolymeric polyamide, polyesters, polyvinyl alcohols, acrylonitrile-butadiene-styrene copolymers, polyarylate, polyacrylate, polyphenylene ether, modified polyphenylene ether, high impact polystyrene, diallyl phthalate polymer, metallocene catalyzed polymers, acrylonitrile-styrene-butadiene (ABS), styrene-acrylonitrile (SAN) (including olefin-modified SAN and acrylonitrile styrene acrylonitrile), styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, and polysiloxane or any metallocene-catalyzed polymers of these species, polyethylene terephthalate, polybutylene terephthalate, polytrimethylene terephthalate, ethylene-carbon monoxide copolymer, polyvinylidene fluorides, polyphenylene sulfide, polypropylene oxide, polypropylene, functionalized polypropylene, polyethylene, ethylene-octene copolymer, ethylene-methyl acrylate (EMA), ethylene-butyl acrylate (EBA), polycarbonate, polysiloxane, functionalized polysiloxane, polyetherester elastomer, polyesterester elastomer, and polyetheramide elastomer. Particularly suitable polymers for use with the SBC/urethane blend or copolymer within the scope of the present invention include: urethane, thermoplastic polyurethane, thermoset polyurethane, copolymeric ionomer, terpolymeric ionomer, propylene-butadiene copolymer, modified copolymer of ethylene and propylene, styrenic copolymer (including styrenic block copolymer and randomly distributed styrenic copolymer, such as styrene-isobutylene copolymer and styrene-butadiene copolymer), partially or fully hydrogenated styrene-butadiene-styrene (SBS) or styrene-isoprene-styrene block copolymers such as styrene-(ethylene-propylene)-styrene (SEPS) or styrene-(ethylene-butadiene)-styrene (SEBS) block copolymers, partially or fully hydrogenated styrene-butadiene-styrene block copolymers with functional group, polymers based on ethylene-propylene-diene monomer (EPDM), polymers based on functionalized EPDM, dynamically vulcanized polypropylene/EPDM copolymer, thermoplastic vulcanizates based on polypropylene or EPDM, natural rubber, styrene-butadiene rubber, butyl rubber, polyisobutylene, chlorinated isobutylene-isoprene rubber, nitrile-isobutylene rubber, 1,2-polybutadiene, 1,4-polybutadiene, cis-polyisoprene, and trans-polyisoprene.

Other preferred materials suitable for use as an additional polymer material in golf balls within the scope of the present invention include polyester elastomers marketed under the tradename SKYPEL by SK Chemicals of South Korea, or triblock copolymers marketed under the tradename SEPTON by Kuraray Corporation of Kurashiki, Japan and KRATON by Kraton Polymers Group of Companies of Chester, United Kingdom. All of the materials listed above may provide for particular enhancements to ball layers in golf balls within the scope of the present invention.

As mentioned above, ionomeric polymers often are found in golf balls. These ionomers also are well suited for blending into golf balls within the scope of the present invention with the copolymer. In particular, preferred compositions incorporating the SBC/urethane copolymers further incorporate ionomeric polymers. These preferred compositions also can preferentially incorporate urethanes along with synthetic or natural rubbers, such as those discussed above. Suitable ionomeric polymers (i.e., copolymer- or terpolymer-type ionomers) for use either with SBC/urethane blends or copolymers include α-olefin/unsaturated carboxylic acid copolymer-type ionomeric or terpolymer-type ionomeric resins that may be described as copolymer EIX/Y, where E represents ethylene, X represents a softening comonomer such as acrylate or methacrylate, and Y is acrylic or methacrylic acid. The acid moiety of Y is neutralized to form an ionomer by a cation such as lithium, sodium, potassium, magnesium, calcium, barium, lead, tin, zinc or aluminum. Also, a combination of such cations is used for the neutralization. Copolymeric ionomers are obtained by neutralizing at least portion of carboxylic groups in a copolymer of an α-olefin and an α,β-unsaturated carboxylic acid having 3 to 8 carbon atoms, with a metal ion. Examples of suitable α-olefins include ethylene, propylene, 1-butene, and 1-hexene. Examples of suitable unsaturated carboxylic acids include acrylic, methacrylic, ethacrylic, α-chloroacrylic, crotonic, maleic, fumaric, and itaconic acid. Copolymeric ionomers include ionomers having varied acid contents and degrees of acid neutralization, neutralized by monovalent or bivalent cations discussed above.

Terpolymeric ionomers are obtained by neutralizing at least a portion of the carboxylic groups in a terpolymer of an α-olefin, and an α,β-unsaturated carboxylic acid having 3 to 8 carbon atoms and an α,β-unsaturated carboxylate having 2 to 22 carbon atoms with metal ion. Examples of suitable α-olefins include ethylene, propylene, 1-butene, and 1-hexene. Examples of suitable unsaturated carboxylic acids include acrylic, methacrylic, ethacrylic, α-chloroacrylic, crotonic, maleic, fumaric, and itaconic acid. Terpolymeric ionomers include ionomers having varied acid contents and degrees of acid neutralization, neutralized by monovalent or bivalent cations discussed above. Examples of suitable ionomeric resins include those marketed under the name SURLYN manufactured by E.I. du Pont de Nemours & Company of Wilmington, Del., and IOTEK manufactured by Exxon Mobil Corporation of Irving, Tex.

Other types of copolymers besides the SBC/urethane copolymers discussed above also may be added to golf balls within the scope of the present invention. Examples of copolymers comprising epoxy, hydroxy, carboxylic acid, maleic anhydride or other functional monomers and which are suitable for use within the scope of the present invention include styrene-butadiene-styrene block copolymers, in which the polybutadiene block contains the functional group, and styrene-isoprene-styrene block copolymers, in which the polyisoprene block contains the functional group. Commercially available examples of epoxy functional copolymers include ESBS A1005, ESBS A1010, ESBS A1020, ESBS AT018, and ESBS AT019, marketed by Daicel Chemical Industries, Ltd. The functional groups may also be added to the copolymers through post-reaction. Such post-reaction may lead to functionalization at any location in the copolymer or at a specific location, for example one or more of the copolymer termini.

Golf balls within the scope of the present invention also may include, in suitable amounts, one or more additional ingredients generally employed in polymer compositions. Agents provided to achieve specific functions, such as additives and stabilizers, may be present. Suitable ingredients include colorants, UV stabilizers, photo stabilizers, antioxidants, colorants, dispersants, mold release agents, processing aids and fillers. The compositions may incorporate, for example, inorganic fillers, such as titanium dioxide, calcium carbonate, zinc sulfide or zinc oxide. Additional fillers may be chosen to impart additional density to the compositions, such as zinc oxide, barium sulfate, tungsten or any other metallic powder having density higher than that of the base polymeric resin. Any organic or inorganic fibers, either continuous or non-continuous, also may be in the composition. An example of these is silica-containing filler, which preferably is selected from finely divided, heat-stable minerals, such as fumed and precipitated forms of silica, silica aerogels and titanium dioxide having a specific surface area of at least about 10 m²/gram.

The SBC/urethane blends or copolymers may be mixed together with other polymers and additives to form portions of the golf balls of the present invention, with or without melting of the components. Dry blending equipment, such as a tumbler mixer, V-blender, or ribbon blender, may be used to mix the compositions. The components may be added using a mill, internal mixer, extruder or combinations of these, with or without application of thermal energy to produce melting. Any combination of the above-mentioned mixing methods may be used to produce a final part of sports equipment within the scope of the present invention.

### EXAMPLES

A series of two-piece (i.e., core and cover) golf balls were prepared within the scope of the present invention. Specifically, the balls were prepared to incorporate covers made from a particular copolymer of styrenic block copolymer and urethane, along with an ionomer. The copolymer used was S5865 copolymer, marketed by Kuraray. The compositions also incorporated Surlyn 6120 ionomer, marketed by DuPont, in varying blend amounts. The particular compositions, identified as A to C, were prepared as provided in Table 1 below, along with tested properties of tensile strength, ultimate elongation, flexural modulus, and Shore D hardness.

TABLE 1

| | Compositions | | Tensile | Ultimate | Flexural | |
|---|---|---|---|---|---|---|
| | SURLYN | | Strength | Elongation | modulus | Shore D |
| | 6120 | S5865 | (psi) | (%) | (psi) | Hardness |
| A | 100 | 0 | 4200 | 130 | 61600 | 63 |
| B | 80 | 20 | 4440 | 340 | 48500 | 56 |
| C | 70 | 30 | 4210 | 430 | 43000 | 53 |
| D | 60 | 40 | 3030 | 380 | 29700 | 49 |

Golf balls were prepared incorporating covers made from compositions B and C. The covers were injection molded over a 1.580 inch commercial polybutadiene rubber core. These balls were tested for spin and velocity when hit by a driver and an 8 Iron. For comparison, three commercial golf balls also were tested for these properties; specifically, the Titleist NXT Tour, the Maxfli Noodle, and the Taylor Made Distance Plus. Results of testing after seven days of aging are shown in Table 2 below.

TABLE 2
USGA Driver Spin Test

| | Back Spin | Ball Velocity | COR |
|---|---|---|---|
| B | 3030 | 165 | 0.817 |
| C | 3090 | 164 | 0.815 |
| NXT Tour | 2860 | 160 | 0.805 |
| Noodle | 2750 | 161 | 0.811 |
| Distance Plus | 2780 | 162 | 0.818 |

8 Iron Spin Test

| | Back Spin | Ball Velocity |
|---|---|---|
| B | 7660 | 112 |
| C | 7610 | 112 |
| NXT Tour | 7380 | 111 |
| Noodle | 7270 | 112 |
| Distance Plus | 7180 | 112 |

With reference to Table 1, compositions incorporating the copolymer of styrenic block copolymer and urethane were softer and more ductile materials as evidenced by the values for ultimate elongation, hardness and flexural modulus, than covers incorporating only the Surlyn 6120. With reference to Table 2, the results of the ball testing indicate that the balls incorporating the copolymer of styrenic block copolymer and urethane in their covers demonstrate an increase in speed off a driver in comparison to the commercial balls, which translates into greater driving distance, while also having an increased spin off the 8 iron, which translates into greater controllability around the putting green.

Although the invention has been disclosed in detail with reference only to the preferred embodiments, those skilled in the art will appreciate that additional compositions can be made without departing from the scope of the invention. Accordingly, the invention is defined only by the claims set forth below.

We claim:

1. A composition comprising a styrenic block copolymer and a urethane.

2. A composition as defined in claim 1, wherein the styrenic block copolymer and urethane are combined to form a random copolymer, a graft copolymer, or a block copolymer.

3. A composition as defined in claim 1, wherein the composition further comprises a polyolefin.

4. A composition as defined in claim 3, wherein the polyolefin is a functionalized polyolefin.

5. A composition as defined in claim 4, wherein the 1% to 30% by weight of monomer units in the functionalized polyolefin comprise a carboxylic acid functional group or an ester functional group.

6. A composition as defined in claim 5, wherein 5% to 25% by weight of monomer units in the functionalized polyolefin comprise a carboxylic acid functional group or an ester functional group.

7. A composition as defined in claim 6, wherein 9% to 16% by weight of monomer units in the functionalized polyolefin comprise a carboxylic acid functional group or an ester functional group.

8. A composition as defined in claim 6, wherein 16% to 25% by weight of monomer units in the functionalized polyolefin comprise a carboxylic acid functional group or an ester functional group.

9. A composition as defined in claim 5, wherein the functionalized polyolefin comprises carboxylic acid functional groups, of which greater than 1% are neutralized.

10. A composition as defined in claim 9, wherein the functionalized polyolefin comprises carboxylic acid groups of which greater than 10% are neutralized.

11. A composition as defined in claim 10, wherein the functionalized polyolefin comprises carboxylic acid groups of which greater than 20% are neutralized.

12. A composition as defined in claim 11, wherein the functionalized polyolefin comprises carboxylic acid groups of which greater than 40% are neutralized.

13. A composition as defined in claim 12, wherein the functionalized polyolefin comprises carboxylic acid groups of which greater than 70% are neutralized.

14. A composition as defined in claim 13, wherein the functionalized polyolefin comprises carboxylic acid groups of which greater than 99% are neutralized.

15. A composition as defined in claim 9, wherein the functionalized polyolefin comprises fatty acid salts.

16. A composition as defined in claim 15, wherein the functionalized polymer is an ionomer.

17. A composition as defined in claim 16, wherein the composition further comprises urethane, rubber, or mixtures thereof.

18. A golf ball incorporating a composition as defined in claim 1.

19. A golf ball incorporating a composition as defined in claim 9.

20. A golf ball incorporating a composition as defined in claim 15.

21. A golf ball incorporating a composition as defined in claim 16.

22. A golf ball as defined in claim 18, wherein the golf ball further comprises UV stabilizers, photo stabilizers, antioxidants, colorants, dispersants, mold releasing agents, processing aids, or fillers.

23. A golf ball as defined in claim 22 wherein the golf ball comprises a filler that increases or decreases the density of the golf ball.

24. A golf ball as defined in claim 18, wherein the golf ball comprises a core and a cover layer over the core, wherein the core or cover layer comprises the composition.

25. A golf ball as defined in claim 24, wherein the golf ball further comprises one or more intermediate layers situated between the core and the cover layer, wherein at least one of the one or more intermediate layers comprise the composition.

26. A golf ball as defined in claim 24, wherein the core comprises an inner core and one or more outer cores encasing the inner core.

27. A golf ball as defined in claim 24, wherein the core comprises liquid.

28. A golf ball as defined in claim 24, further comprising a layer of rubber thread situated between the core and the cover layer of the golf ball.

29. A golf ball as defined in claim 18, wherein the core or cover layer comprises greater than 5% by weight of the styrenic block copolymer and urethane.

30. A golf ball as defined in claim 29, wherein the core or cover layer comprises greater than 10% by weight of styrenic block copolymer and urethane.

31. A golf ball as defined in claim 30, wherein the core or cover layer comprises greater than 20% by weight of styrenic block copolymer and urethane.

32. A golf ball as defined in claim 31, wherein the core or cover layer comprises greater than 40% by weight of styrenic block copolymer and urethane.

33. A method for making a portion of a golf ball, comprising:
preparing a composition comprising styrenic block copolymer and urethane; and
forming the composition into the portion.

34. A method as defined in claim 33, wherein the step of preparing comprises copolymerizing at least a portion of the styrenic block copolymer with the urethane to form a random copolymer, graft copolymer, or block copolymer.

35. A method as defined in claim 33, wherein the step of forming the composition into the portion comprises injection molding the composition to form the portion.

36. A method as defined in claim 33, wherein the step of preparing a composition comprises a step of dry-blending the composition.

37. A method as defined in claim 33, wherein the step of preparing a composition comprises a step of mixing the composition using a mill, internal mixer or extruder.
